(19) United States
(12) Patent Application Publication
(10) Pub. No.: US 2019/0211618 A1
(43) Pub. Date: Jul. 11, 2019

(54) Anti-Theft and Prying-Resistant Door

(71) Applicant: Fengyu Yu, Shanghai City (CN)

(72) Inventor: Fengyu Yu, Shanghai City (CN)

(21) Appl. No.: 16/003,718

(22) Filed: Jun. 8, 2018

(30) Foreign Application Priority Data
Jan. 9, 2018 (CN) 201820034381.9

(51) Int. Cl. E06B 5/11

(52) U.S. Cl. CPC E06B 5/113; E05G 1/026

(57) ABSTRACT

The utility model provides an anti-theft and prying-resistant door, which comprises a door plate and a door frame. The door plate and the door frame are rotatably connected through a hinge. The edge of the door plate is fixedly provided with a lug. The door frame is provided with a groove. The groove is provided with an opening through which the lug enters. The lug is capable of being fit in the groove when the door plate and the door frame are closed. In this way, when the anti-theft and prying-resistant door is closed, the lug may be fixed in the groove in the corresponding position. The edge of the lug between the lug and the groove is capable of being in contact with the edge of the groove.

### CROSS REFERENCE TO RELATED APPLICATION

This application takes priority from and claims the benefit of Chinese Patent Application No. 201820034381.9 filed on Jan. 9, 2018, the contents of which are herein incorporated by reference.

### TECHNICAL FIELD

The utility model relates to the field of security, in particular to an anti-theft and prying-resistant door.

### BACKGROUND

In the prior art, both the lock head and the lock tongue on the anti-theft door are parallel to the door plate. When the door is in the closed state, the lock tongue extends out and is snap-fit in the bayonet to achieve the effect of locking the door. In general, there is always a certain gap between the door plate and the door frame of the anti-theft door when the door plate and the door frame are closed. In the prior art, the door gap is not protected. In this case, thieves may easily pry the door plate with various tools so that the door plate may be deformed and displaced, thereby making the door gap larger and thus enabling the anti-theft door to be opened more easily. In this way, the anti-theft effect of the anti-theft door cannot achieve the desired effect.

Therefore, how to solve the problem that the door gap between the door plate and the door frame is easily increased when the door plate is pried becomes an important technical problem to be solved by those skilled in the art.

### SUMMARY

The purpose of the utility model is to provide an anti-theft and prying-resistant door, so as to solve the problem that the door gap between the door plate and the door frame is easily increased when the door plate is pried.

To achieve the above objectives, the utility model provides the following technical solution.

The utility model provides an anti-theft and prying-resistant door comprising a door plate and a door frame, wherein the door plate and the door frame are rotatably connected through a hinge, wherein the edge of the door plate is fixedly provided with a lug, the door frame is provided with a groove, the groove is provided with an opening through which the lug enters, and the lug is capable of being fit in the groove when the door plate and the door frame are closed.

Preferably, the door plate comprises a first edge, a second edge, a third edge and a fourth edge, the hinge is provided on the first edge, and the lug is provided on the edge formed by the second edge, the third edge and the fourth edge.

Preferably, the lug is provided on one edge of the second edge, the third edge and the fourth edge, and the groove is provided on the door frame corresponding to the edge where the lug is provided.

Preferably, the lug is provided on two edges of the second edge, the third edge and the fourth edge, and the groove is provided on the door frame corresponding to the two edges where the lug is provided.

Preferably, the lug is provided on each edge of the second edge, the third edge and the fourth edge, and the groove is provided on the door frame corresponding to edge where the lug is provided.

Preferably, the lug is provided on two adjacent edges of the door plate in the second edge, the third edge and the fourth edge, two adjacent edges of the door plate are connected to form an end angle, the lug is close to the end angle, and the groove is provided on the door frame corresponding to the edge where the lug is provided.

Preferably, the door plate is rectangular, the lug is provided at the middle position and at both sides of the longer edge of the door plate in the second edge, the third edge and the fourth edge, and the groove is provided on the door frame corresponding to the longer edge of the door plate.

Preferably, the lug has a solid structure.

Preferably, the lug and the door plate form an integral structure.

Preferably, the lug has a circular structure.

The utility model provides an anti-theft and prying-resistant door, which comprises a door plate and a door frame. The door plate and the door frame are rotatably connected through a hinge. The edge of the door plate is fixedly provided with a lug. The door frame is provided with a groove. The groove is provided with an opening through which the lug enters. The lug is capable of being fit in the groove when the door plate and the door frame are closed. In this way, there is a gap between the door plate and the door frame when the door plate and the door frame are in the closed state. The edge of the lug is capable of being in contact with the edge of the groove. After the anti-theft and prying-resistant door is closed, when a tool for prying the door applies a force to the door outwardly, a frictional force can be generated between the lug and the groove, and the direction of the frictional force is opposite to the direction of the force applied to the door by the tool, so as to prevent the displacement and deformation of the door plate, prevent the gap between the door plate and the door frame from increasing, and further strengthen the anti-theft effect of the door.

### BRIEF DESCRIPTION OF THE DRAWINGS

In order to more clearly explain the embodiments of the utility model or the technical solutions in the prior art, the drawings to be used in the description of the embodiments or the prior art will be briefly described below. Obviously, the drawings in the following description are only some embodiments of the utility model. Those skilled in the art may also obtain other drawings based on these drawings without any creative work.

FIG. 1 is a schematic diagram illustrating a structure of an anti-theft and prying-resistant door according to an embodiment of the utility model; and

FIG. 2 is a schematic diagram illustrating a structure of an anti-theft and prying-resistant door when being closed according to an embodiment of the utility model.

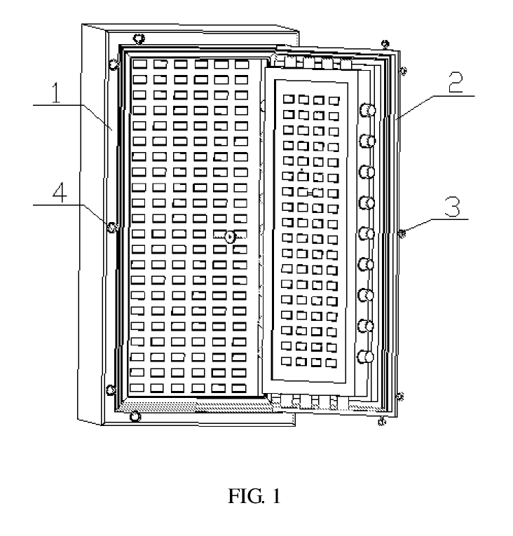

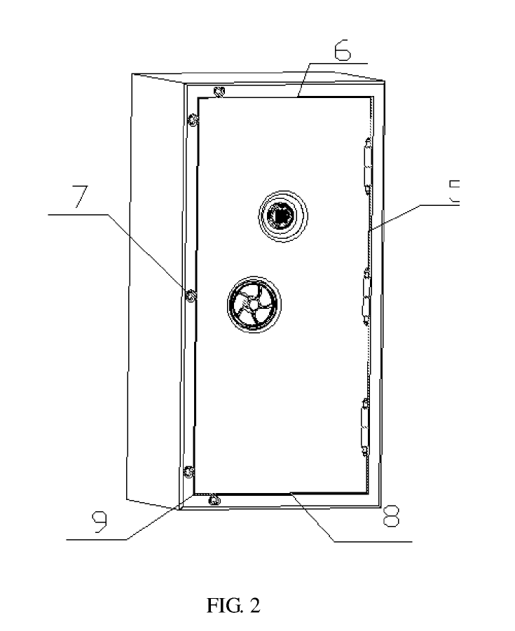

In FIG. 1 to FIG. 2:

A door frame—1, a door plate—2, a lug—3, a groove—4, a first edge—5, a second edge—6, a third edge—7, a fourth edge—8, an end angle—9.

### DESCRIPTION OF THE EMBODIMENTS

This embodiment provides an anti-theft and prying-resistant door, which solves the problem that the gap between the door plate and the door frame is easily increased when the door plate is pried.

Hereinafter, the embodiments will be described with reference to the drawings. In addition, the embodiments shown below do not impose any limitation on the content of the utility model described in the claims. In addition, the whole content of the structure shown by the following embodiment is not limited to what is necessary as a solution of the utility model described in the claims.

Referring to FIG. 1, this embodiment provides an anti-theft and prying-resistant door, comprising a door plate 2 and a door frame 1, wherein the door plate 2 and the door frame 1 are rotatably connected through a hinge, wherein the edge of the door plate 2 is fixedly provided with a lug 3, the door frame 1 is provided with a groove 4, the groove 4 is provided with an opening through which the lug 3 enters, and the lug 3 is capable of being fit in the groove 4 when the door plate 2 and the door frame 1 are closed. In this way, when the door plate 2 and the door frame 1 are closed, a door gap is formed between the door plate 2 and the door frame 1. When the door gap is pried with a tool, frictional force is generated between the lug 3 and the groove 4. The frictional force can prevent the deformation and displacement of the door plate 2, prevent the door gap from increasing, and strengthen the anti-theft effect of the anti-theft and prying-resistant door.

In this embodiment, referring to FIG. 2, the edge of the door plate 2 comprises a first edge 5, a second edge 6, a third edge 7 and a fourth edge 8, the hinge is provided on the first edge 5, the second edge 6, the third edge 7 and the fourth edge 8 form an integral edge, and the lug 3 is provided on the integral edge formed by the three edges. In this way, when the door frame 1 and the door plate 2 are in the closed state, a conflict may be avoided between the position or shape where the lug 3 is provided and the hinge.

In a case of this embodiment, among the second edge 6, the third edge 7, and the fourth edge 8, the lug 3 may be provided only on the second edge 6. The groove 4 is provided on the door frame 1 corresponding to the second edge 6. When the door plate 2 and the door frame 1 are closed, the lug 3 on the second edge 6 may be completely fit in the groove 4. In this way, when the door plate 2 and the door frame 1 are closed, a door gap is formed between the door plate 2 and the door frame 1. When the tool extends into the door gap between the second edge 6 and the door frame 1 to pry the door plate 2, a frictional force will be generated between the lug 3 and the groove 4. The frictional force can prevent the deformation and displacement of the door plate 2 near the second edge 6, prevent the door gap between the second edge 6 and the door frame 1 from increasing, and further strengthen the anti-theft effect of the anti-theft and prying-resistant door. Of course, the lug 3 may also be provided only on the third edge 7 or the fourth edge 8, and the groove 4 is provided on the door frame 1 corresponding to the third edge 7 or the fourth edge 8, which may also correspondingly prevent the door gap between the third edge 7 and the fourth edge 8 and the door frame 1 from increasing.

In another case of this embodiment, among the second edge 6, the third edge 7 and the fourth edge 8 of the door plate 2, the lug 3 may also be provided on the second edge 6 and the fourth edge 8. The groove 4 is provided on the door frame 1 corresponding to the second edge 6 and the fourth edge 8. When the door plate 2 and the door frame 1 are closed, the lugs 3 on the second edge 6 and the fourth edge 8 may be completely fit in the groove 4. In this way, when the door plate 2 and the door frame 1 are closed, a door gap is formed between the door plate 2 and the door frame 1. When the door gap between the second edge 6, the fourth edge 8 and the door frame 1 is pried simultaneously with a tool, a frictional force will be generated between the lug 3 and the groove 4. The frictional force can prevent the deformation and displacement of the door plate 2 near the second edge 6 and the fourth edge 8, prevent the door gap between the second edge 6, the fourth edge 8 and the door frame 1 from increasing, and further strengthen the anti-theft effect of the anti-theft and prying-resistant door. Of course, the lug 3 may also be provided on the second edge 6 and the third edge 7, and the groove 4 is provided on the door frame 1 corresponding to the second edge 6 and the third edge 7, or the lug 3 is provided on the two other edges of the door plate 2 so as to achieve the same goal.

Alternatively, the lug 3 may also be provided on each edge of the second edge 6, the third edge 7 and the fourth edge 8, and the groove 4 is provided on the door frame 1 corresponding to the three edges. In this way, the lugs 3 on the three edges are matched with the groove 4, which may prevent the door plate 2 from being deformed or displaced as a whole. The frictional force generated at the three positions further prevents the door gap between the three edges and the corresponding door frame 1 from increasing so as to further strengthen the anti-theft effect of the anti-theft and prying-resistant door.

Among the second edge 6, the third edge 7 and the fourth edge 8, the second edge 6 is adjacent to the third edge 7. The lug 3 is provided on the second edge 6 and the third edge 7. The second edge 6 and the third edge 7 are connected to form an end angle 9, the lug 3 provided on the second edge 6 and the third edge 7 is close to the end angle 9, and the groove 4 is provided on the door frame 1 corresponding to the second edge 6 and the third edge 7. In this way, the lug 3 is matched with the groove 4, which may simultaneously strengthen the applied force of the two adjacent edges, prevent the door plate 2 near the end angle 9 from deforming, prevent the door gap near the end angle 9 from increasing, and strengthen the anti-theft effect of the anti-theft and prying-resistant door. Similarly, the third edge 7 is adjacent to the fourth edge 8. The end angle 9 is formed at the third edge 7 and the fourth edge 8. The lug 3 is provided on the third edge 7 and the fourth edge 8, respectively. The lug 3 is close to the end corner 9. The groove 4 is provided on the door frame 1 corresponding to the third edge 7 and the fourth edge 8 so as to achieve the same effect.

Referring to FIG. 1, when the door plate 2 is rectangular, the lug 3 is provided at the middle position and at both sides of the longer edge in the second edge 6, the third edge 7 and the fourth edge 8. In a preferred embodiment of this embodiment, the third edge is a longer edge of the door plate 2. The lug 3 is provided both at the middle position and at both sides of the third edge 7, and the groove 4 is provided on the door frame 1 corresponding to the third edge 7. In this way, the frictional force generated at the three positions may more effectively prevent the door gap between the third edge 7 and the door frame 1 from increasing by matching the lug 3 at the three positions on the third edge 7 and the groove 4, further strengthening the anti-theft effect of anti-theft and prying-resistant door.

In the above embodiments, the number of the lugs 3 may be one, two or more, and the number of the grooves 4 is the same as the number of the lugs 3. In this way, the number of the lugs 3 may be set according to the needs of various occasions, such as a home anti-theft door, a safe door, etc.

In this embodiment, the lug 3 is preferably a solid structure. This design not only facilitates the process of machining, but also allows the lug 3 to be better fit with the groove 4. The solid structure may also strengthen the strength of the anti-theft structure and improve the anti-theft effect of the anti-theft and prying-resistant door.

As shown in FIG. 1, the lug 3 and the door plate 2 preferably form an integral structure. For example, the lug 3 and the door plate 2 are formed by integrally cutting. In this way, the lug 3 may be better fixed on the door plate 2 to prevent the lug 3 from falling off due to long-term wear, strengthen the strength of the anti-theft structure, improve the security effect of the anti-theft and prying-resistant door, and further enhance the anti-theft function of the anti-theft and prying-resistant door.

Referring to FIG. 1, the shape of the lug 3 is preferably circular. This design may reduce the production cost of anti-theft and prying-resistant door. Of course, the lug 3 may be of any shape, as long as the lug 3 may be fully fit in the groove 4 when the door plate 2 and the door frame 1 are closed, so as to achieve the same effect and prevent the deformation and displacement of the door plate 2.

This embodiment is based on a safe door. The edge of the door plate 2 of the safe door is provided with a lock tongue. The door frame 1 is provided with a bayonet corresponding to the lock tongue. The lug 3 and the lock tongue are provided in two different areas. In this way, the lug 3 and the bolt may be prevented from interacting with each other.

In the following embodiment, different devices or components in each of the above embodiments will be combined to exemplify the integral structure of the anti-theft and prying-resistant door. An anti-theft and anti-smashing door comprises a door plate 2 and a door frame 1, wherein the door plate 2 and the door frame 1 are rotatably connected through a hinge, wherein the edge of the door plate 2 is provided with a lug 3, the door frame 1 is provided with a groove 4, the groove 4 is provided with an opening through which the lug 3 enters, and the lug 3 is capable of being fit in the groove 4 when the door plate 2 and the door frame 1 are closed. The door plate 2 comprises a first edge 5, a second edge 6, a third edge 7 and a fourth edge 8, the hinge is provided on the first edge 5, and the lug 3 is provided on the edges other than the first edge 5. Among the second edge 6, the third edge 7, and the fourth edge 8, the lug 3 is provided only on the second edge 6, and the groove 4 is provided on the door frame 1 corresponding to the second edge 6; alternatively, among the second edge 6, the third edge 7, and the fourth edge 8, the lug 3 is provided on the third edge 7 and the fourth edge 8, and the groove 4 is provided on the door frame 1 corresponding to the third edge 7 and the fourth edge 8; alternatively, the lug 3 is provided on each edge of the second edge 6, the third edge 7 and the fourth edge 8, and the groove 4 is provided on the door frame 1 corresponding to each edge. Among the second edge 6, the third edge 7 and the fourth edge 8, the lug 3 is provided on the second edge 6 and the third edge 7, the second edge 6 and the third edge 7 are connected to form an end angle 9, the lug 3 is close to the end angle 9, and the groove 4 is provided on the door frame 1 corresponding to the second edge 6 and the third edge 7; when the door plate 2 is rectangular, the lug 3 is provided at the middle position and at both sides of the longer edge in the second edge 6, the third edge 7 and the fourth edge 8, and the groove 4 is provided on the door frame 1 corresponding to the longer edge; the lug 3 is a solid structure, the lug 3 and the door plate 2 preferably form an integral structure, and the shape of the lug 3 is preferably circular. In this way, different numbers of lugs 3 are provided on different edges of the door plate 2, or lugs 3 are provided at different positions on the same edge, so as to meet the needs of various occasions. The solid structure of the lug 3 may allow the lug 3 to be better fit in the groove 4 and make the process of machining simpler, which strengthens the strength of the anti-theft structure. The lug 3 and the door 2 are formed by integrally cutting. In this way, the lug 3 may be better fixed on the door plate 2 to prevent the lug 3 from falling off due to long-term use, and further strengthen the strength of the anti-theft structure. The lug 3 is preferably circular. In this way, the production material may be saved and the production cost may be reduced. In short, the frictional force generated in such a way that the lug 3 is matched with the groove 4 acts on the door plate 2, which may effectively prevent the door gap from increasing when the door is pried with a tool.

The above description enables those skilled in the art to implement or use the utility model. May modifications to these embodiments will be readily apparent to those skilled in the art. The general principles defined herein may be applied to other embodiments without departing from the spirit or scope of the utility model. Thus, the utility model will not be limited to the embodiments shown herein, but will conform to the widest scope consistent with the principles and novel features disclosed herein.

What is claimed is:

1. An anti-theft and prying-resistant door comprising a door plate (2) and a door frame (1), wherein the door plate (2) and the door frame (1) are rotatably connected through a hinge, wherein the edge of the door plate (2) is fixedly provided with a lug (3), the door frame (1) is provided with a groove (4), the groove (4) is provided with an opening through which the lug (3) enters, and the lug (3) is capable of being fit in the groove (4) when the door plate (2) and the door frame (1) are closed.

2. The anti-theft and prying-resistant door according to claim 1, wherein the door plate (2) comprises a first edge (5), a second edge (6), a third edge (7) and a fourth edge (8), the hinge is provided on the first edge (5), and the lug (3) is provided on the edge formed by the second edge (6), the third edge (7) and the fourth edge (8).

3. The anti-theft and prying-resistant door according to claim 2, wherein the lug (3) is provided on one edge of the second edge (6), the third edge (7) and the fourth edge (8), and the groove (4) is provided on the door frame (1) corresponding to the edge where the lug (3) is provided.

4. The anti-theft and prying-resistant door according to claim 2, wherein the lug (3) is provided on two edges of the second edge (6), the third edge (7) and the fourth edge (8), and the groove (4) is provided on the door frame (1) corresponding to the two edges where the lug (3) is provided.

5. The anti-theft and prying-resistant door according to claim 2, wherein the lug (3) is provided on each edge of the second edge (6), the third edge (7) and the fourth edge (8), and the groove (4) is provided on the door frame (1) corresponding to each edge where the lug (3) is provided.

6. The anti-theft and prying-resistant door according to claim 2, wherein the lug (3) is provided on two adjacent edges of the door plate (2) in the second edge (6), the third edge (7) and the fourth edge (8), two adjacent edges of the door plate (2) are connected to form an end angle (9), the lug (3) is close to the end angle (9), and the groove (4) is provided on the door frame (1) corresponding to the edge where the lug (3) is provided.

7. The anti-theft and prying-resistant door according to claim 2, wherein the door plate (2) is rectangular, the lug (3) is provided at the middle position and at both sides of the longer edge of the door plate (2) in the second edge (6), the third edge (7) and the fourth edge (8), and the groove (4) is provided on the door frame (1) corresponding to the longer edge of the door plate (2).

8. The anti-theft and prying-resistant door according to claim 1, wherein the lug (3) has a solid structure.

9. The anti-theft and prying-resistant door according to claim 1, wherein the lug (3) and the door plate (2) form an integral structure.

10. The anti-theft and prying-resistant door according to claim 1, wherein the lug (3) has a circular structure.
